(19) United States
(12) Patent Application Publication
(10) Pub. No.: US 2025/0283377 A1
(43) Pub. Date: Sep. 11, 2025

(54) BUCKET ASSEMBLY AND LADDER IMPLEMENT

(71) Applicants: Heber M. Barlow, Springville, UT (US); Brian Burney, Sandy, UT (US)

(72) Inventors: Heber M. Barlow, Springville, UT (US); Brian Burney, Sandy, UT (US)

(21) Appl. No.: 18/600,083

(22) Filed: Mar. 8, 2024

(51) Int. Cl. E06C 7/14; B65D 25/22

(52) U.S. Cl. CPC E06C 7/14; B65D 25/22

(57) ABSTRACT

A bucket assembly adapted to hang from the top of a ladder, the bucket assembly comprising two elongated shafts in some embodiments, two or more circular base plates for securing buckets, and a hook affixed to a distal end of the first elongated shaft for hanging the bucket assembly from the top of a ladder.

### BACKGROUND OF THE INVENTION

### Field of the Invention

This invention relates to construction, and more particularly relates to an implement adapted to hang from ladders and facilitate contractor function.

### Description of the Related Art

Contractors working on ceiling and upper walls often make use of ladders for painting, welding, applying adhesives, mudding, installing ducts, wiring, and the like. Contractors face a number of unresolved difficulties working atop ladders which are remain in the art, including an inability to efficiency balance paint cans, receptacles, and the need to constantly go up and down the ladder while holding these items.

There is a need in the art for an implement which cures these deficiencies by allowing a contractor to secure paint cans in place atop a ladder and allows the contractor to position these items in place before climbing the ladder. There is a need for an inexpensive implement adapted to affix to any standard ladder. It is an object of the present invention to provide such as an apparatus.

### SUMMARY OF THE INVENTION

From the foregoing discussion, it should be apparent that a need exists for a ladder assembly adapted for interface with standard ladders. Beneficially, such a system and apparatus would overcome many of the difficulties with prior art by providing a simplied assembly easily integratable with standard ladders.

The present invention has been developed in response to the present state of the art, and in particular, in response to the safety problems and needs in the art that have not yet been fully solved by currently available aparati. Accordingly, the present invention has been developed to provide a bucket assembly adapted to hang from the top of a ladder, the bucket assembly comprising: a bracket assembly, the bracket assembly comprising: two or more cylindrical receptacles adapted to receive a base of a bucket; a first elongated shaft; a hook affixed to top end of the first elongated shaft; a second elongated shaft telescopically connected to the first elongated shaft; a plurality of buckets; and two or more detachable protuberances, each protuberance centrally disposed in the bucket, each protuberance comprises a flange.

The receptacles may comprise a circular base having a plurality of upwardly-protruding protuberances adapted to secure a bucket in place.

The first elongated shaft comprises a plurality of apertures through which a bolt inserts, the bolt adapted to secure the first elongated shaft to the second elongated shaft.

A height of the bucket assembly may be adjustable using the telecoping function of the first elongated shaft and the second elongated shaft.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric perspective view of a bucket assembly in accordance with the present invention;

FIG. 2 is a forward perspective view of a bucket assembly in accordance with the present invention;

FIG. 3 is an environmental perspective view of a bucket assembly in accordance with the present invention; and

FIG. 4 is a lower perspective view of a bucket assembly in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

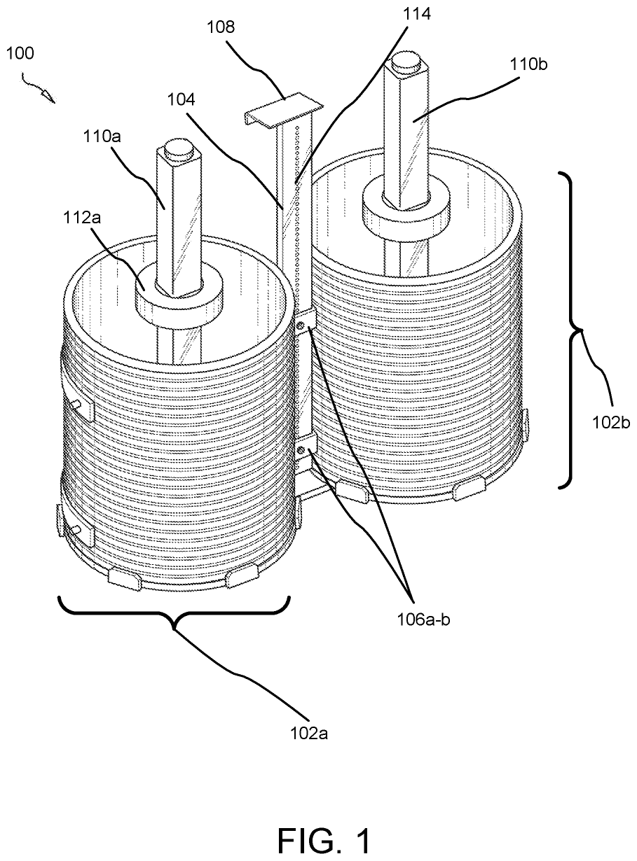

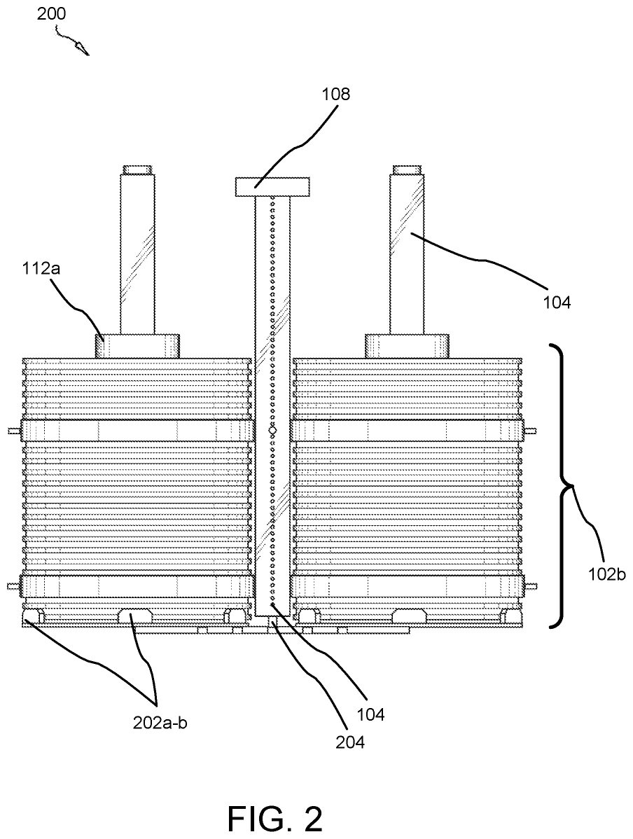

FIGS. 1-2 illustrate various perspective views of a bucket assembly 100, 200 in accordance with the present invention.

The bucket assembly 100 comprises a first elongated shaft 104 which may be formed from metal, metal allow, polymeric materials and/or organic materials such as wood or leather. The first elongated shaft 104 may be tubular, rectangular, or a shaft. The first elongated shaft 104 may telescopically connect to a second elongated shaft 204. In some embodiments, the second elongated shaft 204 inserts into a hollow recess defined by the first elongated shaft 104. In other embodiments, the first elongated shaft 104 inserts into a hollow recess defined by the second elongated shaft 204.

A forward or rearward surface of the first elongated shaft 104 may define a plurality of apertures 104 into which one or more bolts insert and traverse. These bolts may affix the first elongated shaft 104 to the second elongated shaft 204.

In various embodiments, one of the first elongated shaft and the second elongated shaft is affixed to one of a lateral bracket 404, further described below, and two or more baseplates 402.

A hook 108 affixes to the top end (i.e., distal end) of the first elongated shaft 104 or the second elongated shaft 104. The hook 108 comprises a cantilever adapted to hang from the top of a ladder.

The proximal end of the second elongated shaft 204 may affix to the lateral bracket 404.

In various embodiments, the circular base plates 402 comprise a plurality of protuberances 202 which jut superiorly from the circular base plates 402. These protuberances 202 may be spaced at even intervals around the perimeters of the circular baseplates 402.

The exterior of the buckets 102 may be corrugated. The buckets 102 may comprise cylindrical receptacles for receiving a bucket of paint.

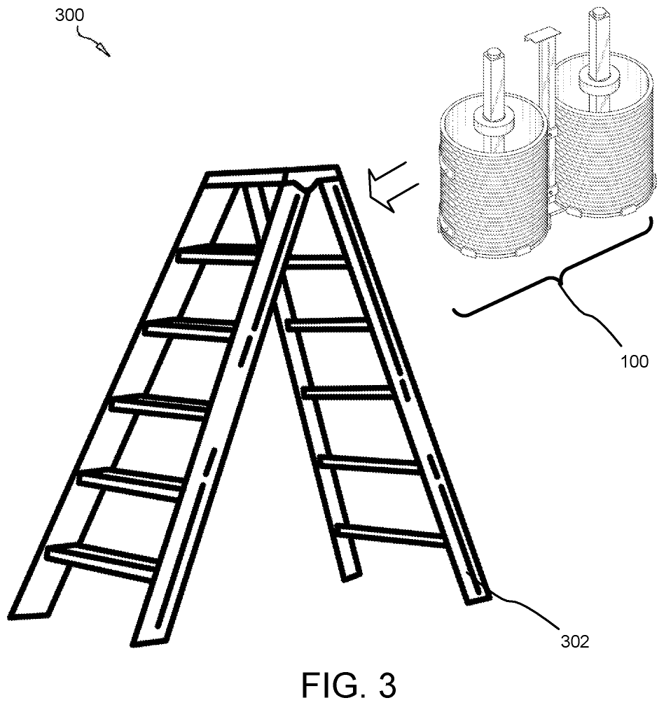

FIG. 3 is an environmental perspective view of a bucket assembly 300 in accordance with the present invention.

As shown, the bucket assembly 100 affixes to the top of a ladder 302. The bucket assembly 300 may hang from a rung on the ladder 302 or may hang from a top beam or step using the hook 108.

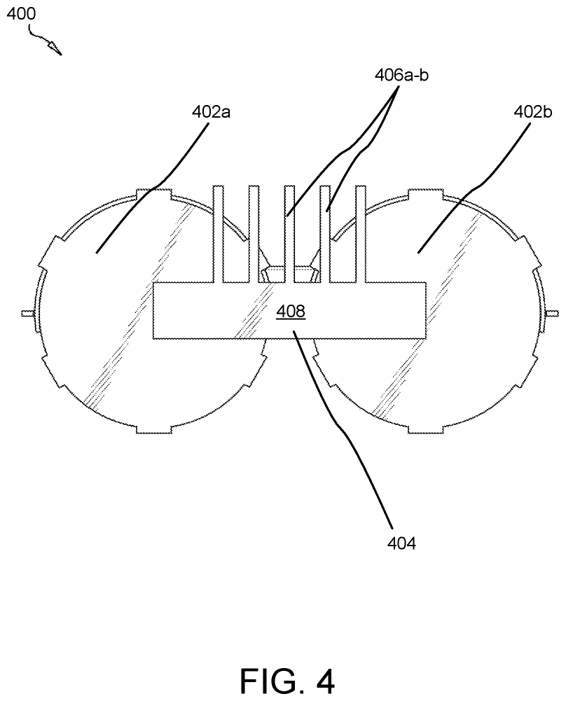

FIG. 4 is a lower perspective view of a bucket assembly 400 in accordance with the present invention.

The lateral bracket 404 may affix on a top surface or otherwise to the second elongated shaft 204. The lateral bracket 404 may affix to, and support, the circular base plates 402a-b disposed above the lateral bracket 404.

In some embodiments, one or more stabilizers 406 jut rearwardly from the lateral bracket 404. The stabilizers 406 space the buckets 102a-b away from the stringers of the ladder 302. The stablizers 406 may affix to a rearward surface of the main body 408 of the lateral bracket 404. The stablizers 406 may comprise rectangular tabs spaced evenly apart form one another.

The embodiments 100-400 may comprise or consist of each indicated component.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A bucket assembly adapted to hang from the top of a ladder, the bucket assembly comprising:
a bracket assembly, the bracket assembly comprising:
two or more cylindrical receptacles adapted to receive a base of a bucket;
a first elongated shaft;
a hook affixed to top end of the first elongated shaft;
a second elongated shaft telescopically connected to the first elongated shaft;
a plurality of buckets; and
two or more detachable protuberances, each protuberance centrally disposed in the bucket, each protuberance comprises a flange.

2. The bucket assembly of claim 1, wherein the receptacles comprise a circular base having a plurality of upwardly-protruding protuberances adapted to secure a bucket in place.

3. The bucket assembly of claim 1, wherein the first elongated shaft comprises a plurality of apertures through which a bolt inserts, the bolt adapted to secure the first elongated shaft to the second elongated shaft.

4. The bucket assembly of claim 3, wherein a height of the bucket assembly is adjustable using the telecoping function of the first elongated shaft and the second elongated shaft.
